(19) United States
(12) Patent Application Publication
(10) Pub. No.: US 2024/0339704 A1
(43) Pub. Date: Oct. 10, 2024

(54) BUTTON-TYPE SECONDARY BATTERY

(71) Applicant: LG ENERGY SOLUTION, LTD., Seoul (KR)

(72) Inventors: Min Gyu KIM, Daejeon (KR); Joo Hwan SUNG, Daejeon (KR); Min Su CHO, Daejeon (KR); Geun Young PARK, Daejeon (KR)

(73) Assignee: LG ENERGY SOLUTION, LTD., Seoul (KR)

(21) Appl. No.: 18/289,732

(22) PCT Filed: Oct. 6, 2022
(86) PCT No.: PCT/KR2022/015050

§ 371 Date: Jun. 20, 2024

(30) Foreign Application Priority Data
Oct. 6, 2021 (KR) 10-2021-0132754

(51) Int. Cl. H01M 50/169; H01M 10/04; H01M 50/109; H01M 50/153; H01M 50/188

(52) U.S. Cl. CPC H01M 50/169; H01M 10/0431; H01M 50/109; H01M 50/153; H01M 50/188

(57) ABSTRACT

A button-type secondary battery includes an electrode assembly; a can having an open end and accommodating the electrode assembly; a base plate sealing the open end of the can; an electrode terminal passing through a through-hole of the base plate; and an insulating gasket insulating the electrode terminal from the base plate. The open end includes a first-a inclined surface inclined with respect to an inner surface and a first-b inclined surface inclined with respect to an outer surface and having an upper end connected to an upper end of the first-a inclined surface. An edge portion of the base plate includes a second-a inclined surface inclined with respect to a bottom surface and in contact with the first-a inclined surface and a second-b inclined surface inclined with respect to a top surface and having a lower end connected to an upper end of the second-a inclined surface.

### CROSS-REFERENCE TO RELATED APPLICATION

The present application claims the benefit of the priority of Korean Patent Application No. 10-2021-0132754, filed on Oct. 6, 2021, which is hereby incorporated by reference in its entirety.

### TECHNICAL FIELD

The present invention relates to a button-type secondary battery capable of improving a coupling structure between an edge portion of a base plate and an opening end of a can to remove a sharp edge.

### BACKGROUND ART

In general, secondary batteries refer to chargeable and dischargeable, unlike primary batteries that are not chargeable. The secondary batteries are being widely used for mobile phones, notebook computers, and camcorders, electric vehicles, and the like.

The secondary battery may include a button-type secondary battery having high energy density, high output, and long lifespan, and the button-type secondary battery includes an electrode assembly, a can accommodating the electrode assembly and connected to a negative electrode tab of the electrode assembly, a base plate coupled to the can, an electrode terminal connected to a positive electrode tab of the electrode assembly through the base plate, and a gasket insulating the electrode terminal and the base plate from each other and sealing a gap between the electrode terminal and the base plate.

A close contact surface on which an opening end of the can and an edge portion of the base plate are in close contact with each other is formed as an inclined surface and coupled through a welding method. Thus, adhesion, bonding force, and sealing force between the can and the base plate may increase.

However, the button-type secondary battery described above has a problem in that the sharp edge is formed on the close contact surface, on which the opening end of the can and the edge portion of the base plate are in close contact with each other to cause damage of a structure disposed outside the button-type secondary battery, particularly, a problem in that a welding part is formed on the sharp edge to increase in outer diameter of the button-type secondary battery.

### DISCLOSURE OF THE INVENTION

### Technical Problem

A button-type secondary battery of the present invention for solving the above problems is to provide a button-type secondary battery, in which a coupling structure between an edge portion of a base plate and an opening end of a can is improved to remove a sharp edge, and thus, prevent an outer diameter of the button-type secondary battery from increasing, particularly, to prevent a structure disposed outside of the button-type secondary battery from being damaged.

### Technical Solution

A button-type secondary battery of the present invention for achieving the above object may include: an electrode assembly in which electrodes and a separator are wound; a can configured to accommodate the electrode assembly and connected to a first electrode tab of the electrode assembly; a base plate coupled to an opening end of the can to seal the can; an electrode terminal configured to pass through a through-hole of the base plate and connected to a second electrode tab of the electrode assembly; and an insulating gasket configured to insulate the electrode terminal and the base plate from each other, wherein the opening end of the can is provided as a first-a inclined surface formed to be inclined with respect to an inner surface and a first-b inclined surface formed to be inclined with respect to an outer surface and having an upper end connected to an upper end of the first-a inclined surface, and an edge portion of the base plate is provided as a second-a inclined surface formed to be inclined with respect to a bottom surface and in close contact with the first-a inclined surface and a second-b inclined surface formed to be inclined with respect to a top surface and having a lower end connected to an upper end of the second-a inclined surface.

A connection point of the first-a inclined surface and the first-b inclined surface and a connection point of the second-a inclined surface and the second-b inclined surface may be provided to be in contact with each other, and contact points between the connection point of the first-a inclined surface and the first-b inclined surface and the connection point of the second-a inclined surface and the second-b inclined surface may be coupled to each other by laser welding.

A first inclination angle between the first-a inclined surface and the first-b inclined surface and a second inclination angle between the second-a inclined surface and the second-b inclined surface may be the same.

Each of the first inclination angle and the second inclination angle may be provided as an angle of 90°.

Each of the first inclination angle and the second inclination angle may be provided to be greater than an angle of 90°.

Each of the first inclination angle and the second inclination angle may be provided to be less than an angle of 90°.

A length of each of the first-b inclined surface and the second-b inclined surface may be provided to be less than a length of each of the first-a inclined surface and the second-a inclined surface.

Each of the first-b inclined surface and the second-b inclined surface may be provided as a horizontal surface.

A connection point between an outer circumferential surface of the can and the first-b inclined surface may be provided as a curved surface.

A connection point between a top surface of the base plate and the second-b inclined surface may be provided as a curved surface.

The electrode terminal, the insulating gasket, and the base plate may be bonded to each other through thermal fusion.

### Advantageous Effects

In the button-type secondary battery of the present invention, which has the above configuration, the coupling force between the edge portion of the base plate and the opening end of the can may increase, and also, the sharp edge may be removed, and thus, the external exposure of the welding part, at which the edge portion of the base plate and the opening end of the can are welded to each other, may be minimized, and the structure disposed outside the button-type secondary battery may be prevented from being damaged. Particularly, the outer diameter of the secondary battery may be prevented from increasing.

### BRIEF DESCRIPTION OF THE DRAWINGS

FIG. 1 is a cross-sectional view of a button-type secondary battery according to a first embodiment of the present invention.

FIG. 2 is an enlarged cross-sectional view illustrating a state in which an opening end of a can and an edge portion of a base plate are separated from each other in FIG. 1.

FIG. 3 is an enlarged cross-sectional view illustrating a state in which an opening end of a can and an edge portion of a base plate are welded to each other in FIG. 1.

FIG. 4 is a cross-sectional view of a button-type secondary battery according to a second embodiment of the present invention.

FIG. 5 is a cross-sectional view of a button-type secondary battery according to a third embodiment of the present invention.

FIG. 6 is a cross-sectional view of a button-type secondary battery according to a fourth embodiment of the present invention.

### MODE FOR CARRYING OUT THE INVENTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

### [Button-Type Secondary Battery According to First Embodiment of the Present Invention]

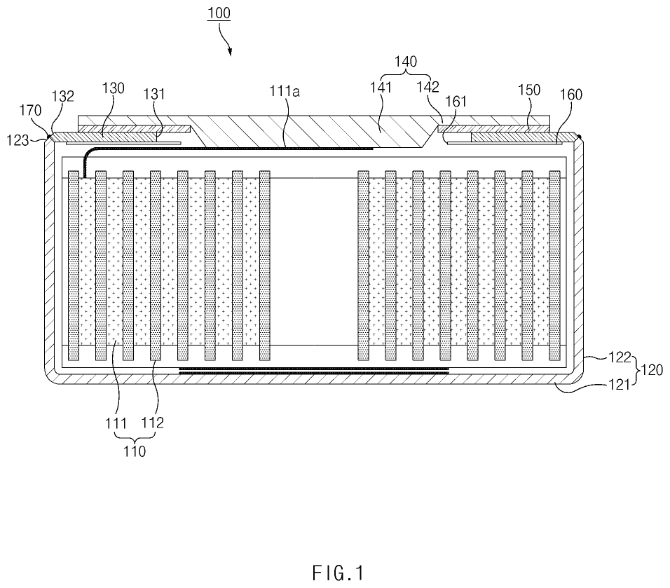

As illustrated in FIGS. 1 to 3, a button-type secondary battery 100 according to the first embodiment of the present invention may be a button-type secondary battery 100 of which a diameter is greater than a height. In addition, the button-type secondary battery 100 includes an electrode assembly 110, a can 120, a base plate 130, an electrode terminal 140, an insulating gasket 150, and an insulating sheet 160.

### Electrode Assembly

Referring to FIG. 1, the electrode assembly 110 may be formed by alternately disposing a positive electrode, a separator, and a negative electrode. That is, the electrode assembly 110 may be a jelly-roll type electrode assembly 110 in which electrodes 111 and separators 112 are alternately disposed to be wound in a jelly-roll shape. The electrode assembly 110 may be an electrode wound body in which one or more positive electrodes, one or more negative electrodes, and one or more separators are wound on each other.

The electrode assembly 110 includes a first electrode tab and a second electrode tab 111a, the first electrode tab is connected to the can 120, and the second electrode tab 111a is connected to the electrode terminal 140. Here, the first electrode tab may be a negative electrode tab, and the second electrode tab 111a may be a positive electrode tab.

### Can

Referring to FIG. 1, the can 120 may be configured to accommodate the electrode assembly 110. The can 120 may have an internal space, and the electrode assembly 110 may be vertically inserted into the internal space. The vertical insertion may mean that the electrode assembly 110 is inserted so that a winding axis of the electrode assembly is perpendicular to a bottom part of the can 120. Referring to FIG. 1, the can 120 may have an opening at an upper side.

That is, the can 120 has an opened upper side and includes a bottom part 121 and a sidewall 122, and an opening end 123 is formed at an upper end of the sidewall 122.

### Base Plate

Referring to FIG. 1, the base plate 130 may be coupled to an upper opening of the can 120 to seal the can 120. This bonding may be bonding using welding. Specifically, an edge portion 132 of the base plate 130 and the opening end 123 of the can 120 may be coupled to each other by laser welding. A portion at which the edge portion 132 of the base plate 130 and the opening end 123 of the can 120 are welded to each other by welding may be a welding part 170.

Also, this type of laser welding may be seam welding that is advantageous for preventing a welding pin hole. In addition, a through-hole 131 may be formed in an inner center of the base plate 130. Here, the base plate may be made of a metal material, and the metal material may be at least one or more selected from SUS, nickel-plated carbon steel, and Al.

### Electrode Terminal

Referring to FIG. 1, the electrode terminal 140 may be a terminal coupled to the through-hole 131 formed in a top surface of the base plate 130. The electrode terminal 140 may be a positive electrode terminal having a positive pole. This may be a result of a second electrode tab 111a of the electrode assembly 110 being connected to the electrode terminal 140. FIG. 1 illustrates a state in which the second electrode tab 111a extending from the electrode is connected to a bottom surface of the electrode terminal 140. This bonding may be bonding using the welding.

When the electrode terminal 140 has positive polarity, each of the can 120 and the base plate 130 may have negative polarity. The negative electrode of the electrode assembly 110 may be connected to the can 120 so that the can 120 has the negative polarity. As the base plate 130 is welded to the can 120, the base plate 120 may have the same negative polarity as the can 120. The negative electrode tab, which is the first electrode tab of the electrode assembly, may be connected to the bottom part 121 of the can 120.

At least a portion of the electrode terminal may be configured to be inserted into the through-hole 131 formed inside the base plate 130 so as to cover the through-hole 131. The electrode terminal 140 may be made of a metal material, and the metal material may be any one or more selected from SUS, nickel-plated carbon steel, and Al. The electrode terminal 140 may be configured to be connected to the electrode 111 of the electrode assembly 110 through the second electrode tab 111a and may be a portion forming a terminal through which the battery is connected to an external device.

For example, the electrode terminal 140 may include an insertion part 141 inserted into the through-hole 131 and a terminal plate part 142 extending outward from an upper end of the insertion part 141 and extending to have a plate shape.

Here, the insertion part 141 may have a shape of which a cross-sectional diameter gradually decreases as the insertion part 141 descends in a direction closer to the electrode assembly 110. An insertion hole 161 may be formed inside the insulating sheet 160. In this case, a lower end of the insertion part 141 may be inserted into the insertion hole 161 of the insulating sheet 160. When having such a structure, the lower end of the insertion part 141 may not be in contact with the insulating sheet 160. That is, the lower end of the insertion part 141 may not touch or press the insulating sheet 160.

Also, the second electrode tab 111a of the electrode assembly 110 may extend from the electrode 111 of the electrode assembly 110 so as to be in contact with the electrode terminal 140. In this case, the second electrode tab 111a may extend from the positive electrode of the electrode assembly 110 so as to be in contact with the electrode terminal 140.

### Insulating Gasket

Referring to FIG. 1, the insulating gasket 150 may be configured to insulate and seal the electrode terminal 140 and the base plate 130. That is, the insulating gasket 140 may be configured to prevent short circuit from occurring between the electrode terminal 140 and the base plate 130. When the electrode terminal 140 has the positive pole, since the base plate 130 bonded to the body of the can 120 that has a negative pole has a negative pole, and the electrode terminal 40 has a positive pole, a structure that insulates the electrode terminal 140 from the base plate is required. The structure is an insulating gasket 150.

In addition, the electrode terminal 140, the insulating gasket 150, and the base plate 130 may be bonded to each other by thermal fusion. In the related art, a rivet structure is used to couple the electrode terminal 140. However, in the button-type secondary battery 100 according to Embodiment 1 of the present invention, a thermal fusion structure instead of the rivet structure may be used.

### Insulating Sheet

Referring to FIG. 1, the insulating sheet 160 may be disposed on a bottom surface of the base plate 130 and may be configured to insulate the bottom surface of the base plate 130. The insulating sheet 160 may insulate the base plate 130 and the second electrode tab from each other. In addition, the insulating sheet 160 may insulate the base plate 130 and the electrode assembly 110 from each other.

In addition, the insulating sheet 160 may be attached to the bottom surface of the base plate 130. When attached as described above, the insulating sheet 160 may be stably disposed without moving.

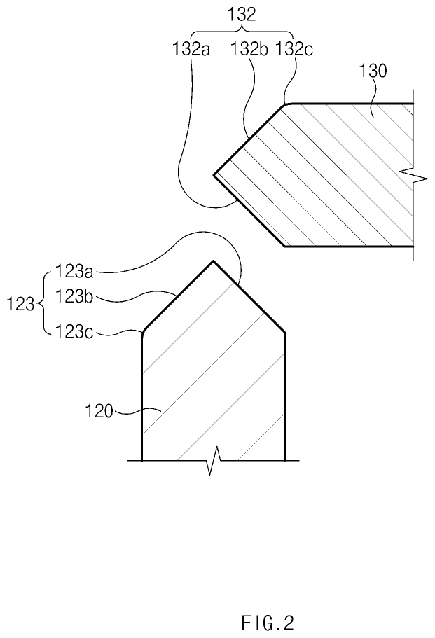

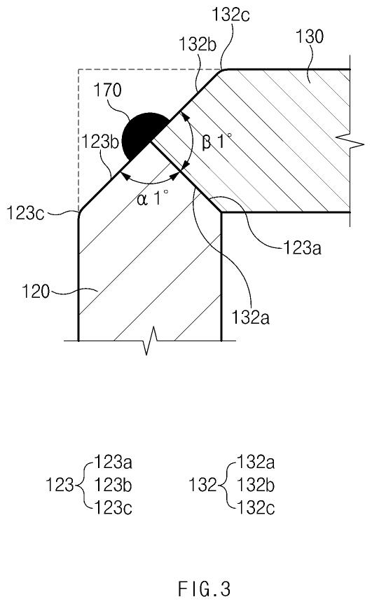

Referring to FIGS. 2 and 3, a button-type secondary battery 100 according to Embodiment 1 of the present invention has a structure, in which an edge portion 132 of a base plate 130 and an opening end 123 of a can 120 are coupled to each other to form an inclined surface, particularly, a coupling structure in which a sharp edge is removed.

That is, the opening end 123 of the can 120 has a first-a inclined surface 123a inclined with respect to an inner surface (a right surface of the opening end when viewed in FIG. 2) and a first-b inclined surface 123b inclined with respect to an outer surface (a left surface of the opening end when viewed in FIG. 2) and having an upper end connected to an upper end of the first-a inclined surface 123a. That is, the opening end 123 of the can 120 has a wedge-shaped structure in which the first-a inclined surface 123a and the first-b inclined surface 123b are connected to each other.

In addition, the edge portion 132 of the base plate 130 may have a second-a inclined surface 132a inclined with respect to a bottom surface (a bottom surface of the edge portion when viewed in FIG. 2) and in close contact with the first-a inclined surface 123a and a second-b inclined surface 132b inclined with a top surface (a top surface of the edge portion when viewed in FIG. 2) and having a lower end connected to an upper end of the second-a inclined surface 132a. That is, the edge portion 132 of the base plate 130 has a wedge-shaped structure in which the second-a inclined surface 132a and the second-b inclined surface 132b are connected to each other.

In summary, while the first-a inclined surface 123a and the second-a inclined surface 132a are in close contact with each other, a coupling property between the edge 132 of the base plate 130 and the opening end 123 of the can 120 may increase, and while the first-b inclined surface 123b and the second-b inclined surface 132b are formed outside the button-type secondary battery, a sharp edge with respect to the edge portion 132 of the base plate 130 and the opening end 123 of the can 120 may be removed. Thus, external protrusion of a welding part 170 at which the edge portion of the base plate and the opening end of the can are welded to each other may be minimized, and a structure disposed outside the button-type secondary battery may be prevented from being damaged. Particularly, an outer diameter of the secondary battery may be prevented from increasing.

Here, referring to FIG. 2, a connection point of the first-a inclined surface 123a and the first-b inclined surface 123b and a connection point of the second-a inclined surface 132a and the second-b inclined surface 132b may be provided to be in contact with each other. In addition, the connection point of the first-a inclined surface 123a and the first-b inclined surface 123b and the connection point of the second-a inclined surface 132a and the second-b inclined surface 132b may be coupled to each other by laser welding to form a welding part 170. Thus, a stepped portion may be prevented from being formed between the connection point of the first-a inclined surface 123a and the first-b inclined surface 123b and the connection point of the second-a inclined surface 132a and the second-b inclined surface 132b, and the welding part 170 may be stably formed.

Each of the first-b inclined surface 123b and the second-b inclined surface 132b is provided as a horizontal surface for ease of processing. Alternatively, each of the first-b inclined surface 123b and the second-b inclined surface 132b may not be limited to the horizontal surface and may also be formed on a curved surface.

An inclination angle of the first-a inclined surface 123a inclined with respect to an inner surface of the can 120 and an inclination angle of the second inclined surface 132a inclined with respect to a bottom surface of the base plate may be the same.

A first inclination angle α1° between the first-a inclined surface 123a and the first-b inclined surface 123b and a second inclination angle β1° between the second-a inclined surface 132a and the second-b inclined surface 132b may be the same. That is, each of the first inclination angle α1° and the second inclination angle β1° may be provided as an angle of 90°. Thus, the first-b inclined surface 123b and the second-b inclined surface 132b have the same horizontality, and as a result, a stepped portion or a curve may be prevented from occurring between the first-b inclined surface 123b and the second-b inclined surface 132b.

A connection point between the first-b inclined surface 123b and an outer circumferential surface of a sidewall 122 provided in the can 120 may be provided as a curved surface 123c. Thus, a sharp edge between the first-b inclined surface 123b and the outer circumferential surface of a wall surface may be removed.

A connection point between the second-b inclined surface 132b and a top surface of the base plate 130 may be provided as a curved surface 132c. Thus, a sharp edge between the second-b inclined surface 132b and the top surface of the base plate 130 may be removed.

Therefore, the button-type secondary battery 100 according to Embodiment 1 of the present invention, which has the configuration as described above, may have a coupling property between the edge portion 132 of the base plate 130 and the opening end 123 of the can 120, and the sharp edge of an outer point, at which the edge portion 132 of the base plate 130 and the opening end 123 of the can 120 meet each other may be removed. Thus, external protrusion of the welding part, at which the edge portion of the base plate and the opening end of the can are welded to each other, may be minimized, and an outer diameter of the secondary battery may be prevented from increasing. Particularly, a structure disposed outside the button-type secondary battery may be prevented from being damaged.

Hereinafter, in descriptions of another embodiment of the present invention, constituents having the same function as the above-mentioned embodiment have been given the same reference numeral in the drawings, s duplicated description will be omitted.

### [Button-Type Secondary Battery According to Second Embodiment of the Present Invention]

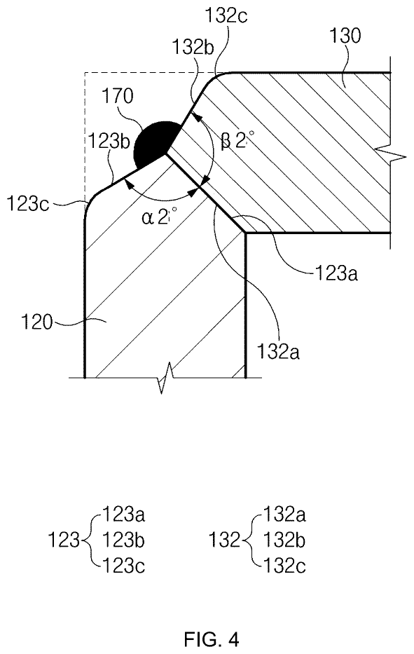

As illustrated in FIG. 4, in a button-type secondary battery 100 according to a second embodiment of the present invention, each of a first inclination angle α2° between a first-a inclined surface 123a and a first-b inclined surface 123b and a second inclination angle β2° between a second-a inclined surface 132a and a second-b inclined surface 132b may be provided as an angle greater than an angle of 90°.

That is, each of the first inclination angle α2° and the second inclination angle β2° may be an angle of 95° to 120°, and preferably, the first inclination angle α2° and the second inclination angle 2° may be an angle of 100° to 110°.

Therefore, in the button-type secondary battery 100 according to the second embodiment of the present invention, a welding part 170 at which an edge portion 132 of a base plate 130 and an opening end 123 of a can 120 are welded to each other may be formed at a more inner side, and thus, external protrusion of the welding part may be significantly prevented.

### [Button-Type Secondary Battery According to Third Embodiment of the Present Invention]

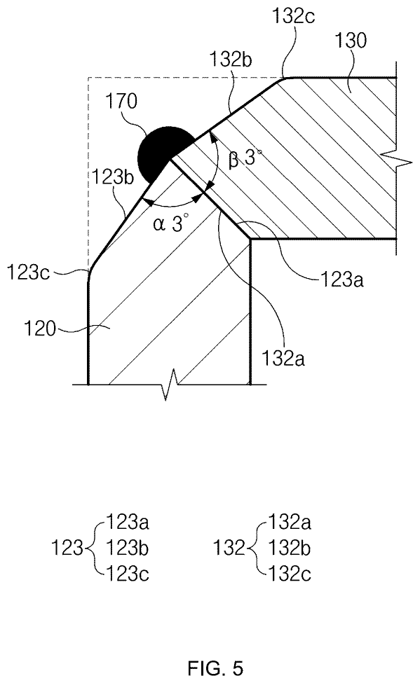

As illustrated in FIG. 5, in a button-type secondary battery 100 according to a third embodiment of the present invention, each of a first inclination angle α3° between a first-a inclined surface 123a and a first-b inclined surface 123b and a second inclination angle β3° between a second-a inclined surface 132a and a second-b inclined surface 132b may be provided as an angle less than an angle of 90°.

That is, each of the first inclination angle α3° and the second inclination angle β3° may be an angle of 75° to 89°, and preferably, the first inclination angle α3° and the second inclination angle β3° may be an angle of 80° to 85°.

Therefore, in the button-type secondary battery 100 according to the second embodiment of the present invention, each of inclination angles between the first-b inclined surface 123b and an outer circumferential surface of a sidewall and between the second-b inclined surface 132b and a top surface of the base plate 130 may be formed more gently, and as a result, a sharp edge may be greatly prevented from being formed.

### [Button-Type Secondary Battery According to Fourth Embodiment of the Present Invention]

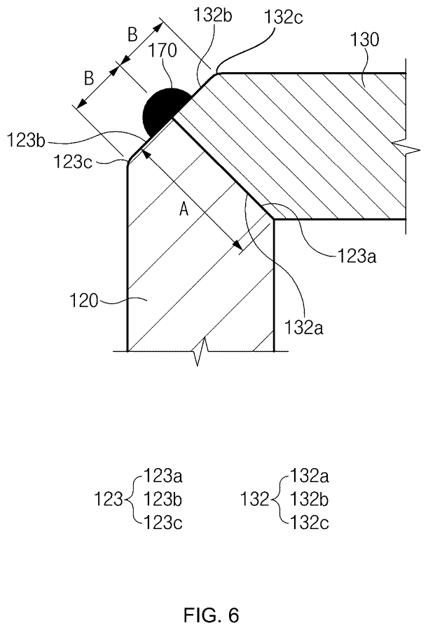

As illustrated in FIG. 6, in a button-type secondary battery 100 according to a fourth embodiment of the present invention, a lengths B of each of a first-b inclined surface 123b and a second-b inclined surface 132b may be less than a length A of each of a first-a inclined surface 123a and a second inclined surface 132a.

That is, the length A of each of the first-a inclined surface 123a and the second-a inclined surface 132a may be formed to be larger than the length B of each of the first-b inclined surface 123b and the second-b inclined surface 132b to greatly increase in coupling force.

Here, referring to FIG. 6, the length of the first-a inclined surface 123a refers to a length from a lower end to an upper end of the first-a inclined surface 123a when viewed from a thickness direction of a can. In addition, referring to FIG. 6, the length of the second-a inclined surface 132a refers to a length from a lower end to an upper end of the second-a inclined surface 132a when viewed in a thickness direction of a base plate. In addition, referring to FIG. 6, the length of each of the first-b inclined surface 123b and the second-b inclined surface 132b refers to a length from a lower end to an upper end of a close contact surface between the first-b inclined surface 123b and the second-b inclined surface 132b.

Therefore, in the button-type secondary battery 100 according to the fourth embodiment of the present invention, the close contact surface between the first-a inclined surface and the second-a inclined surface may be significantly secured to increase in coupling force between the can and the base plate.

Accordingly, the scope of the present invention is defined by the appended claims more than the foregoing description and the exemplary embodiments described therein. Various modifications made within the meaning of an equivalent of the claims of the invention and within the claims are to be regarded to be in the scope of the present invention.

### DESCRIPTION OF THE SYMBOLS

100: Button-type secondary battery
110: Electrode assembly
111: Electrode
112: Separator
120: Can
121: Bottom part
122: Sidewall
123: Opening end
123a: First-a inclined surface
123b: First-b inclined surface
123c, 132c: Curved surface
130: Base plate
131: Through-hole
132: Edge portion
132a: Second-a inclined surface
132b: Second-b inclined surface
140: Electrode terminal
141: Insertion part
142: Terminal plate part
150: Insulating gasket
160: Insulating sheet
161: Insertion hole
170: Welding part

1. A button-type secondary battery comprising:
an electrode assembly in which electrodes and a separator are wound;
a can having an open end and configured to accommodate the electrode assembly, the can being connected to a first electrode tab of the electrode assembly;
a base plate coupled to the open end of the can to seal the can;
an electrode terminal configured to pass through a through-hole of the base plate and connected to a second electrode tab of the electrode assembly; and
an insulating gasket configured to insulate the electrode terminal and the base plate from each other,
wherein the open end of the can is provided as a first-a inclined surface to be inclined with respect to an inner surface and a first-b inclined surface to be inclined with respect to an outer surface and having an upper end connected to an upper end of the first-a inclined surface, and
wherein an edge portion of the base plate is provided as a second-a inclined surface to be inclined with respect to a bottom surface and in contact with the first-a inclined surface and a second-b inclined surface to be inclined with respect to a top surface and having a lower end connected to an upper end of the second-a inclined surface.

2. The button-type secondary battery of claim 1, wherein a connection point of the first-a inclined surface and the first-b inclined surface and a connection point of the second-a inclined surface and the second-b inclined surface are in contact with each other, and
wherein contact points between the connection point of the first-a inclined surface and the first-b inclined surface and the connection point of the second-a inclined surface and the second-b inclined surface are coupled to each other by laser welding.

3. The button-type secondary battery of claim 1, wherein a first inclination angle between the first-a inclined surface and the first-b inclined surface and a second inclination angle between the second-a inclined surface and the second-b inclined surface are the same.

4. The button-type secondary battery of claim 3, wherein each of the first inclination angle and the second inclination angle is 90°.

5. The button-type secondary battery of claim 3, wherein each of the first inclination angle and the second inclination angle is 90°.

6. The button-type secondary battery of claim 3, wherein each of the first inclination angle and the second inclination angle is less than 90°.

7. The button-type secondary battery of claim 1, wherein a length of each of the first-b inclined surface and the second-b inclined surface is less than a length of each of the first-a inclined surface and the second-a inclined surface.

8. The button-type secondary battery of claim 1, wherein each of the first-b inclined surface and the second-b inclined surface is a horizontal surface.

9. The button-type secondary battery of claim 1, wherein a connection point between an outer circumferential surface of the can and the first-b inclined surface is a curved surface.

10. The button-type secondary battery of claim 1, wherein a connection point between a top surface of the base plate and the second-b inclined surface is a curved surface.

11. The button-type secondary battery of claim 1, wherein the electrode terminal, the insulating gasket, and the base plate are bonded to each other through thermal fusion.
